(19) United States
(12) Patent Application Publication
(10) Pub. No.: US 2026/0307973 A1
(43) Pub. Date: Oct. 8, 2026

(54) CONTAINER ATTACHMENT

(71) Applicant: Silz & Lemp GmbH, Melle (DE)

(72) Inventors: Torben Silz, Hagen a.T.W. (DE); Justus LEMP, Melle (DE)

(73) Assignee: Silz & Lemp GmbH, Melle (DE)

(21) Appl. No.: 19/476,506

(22) PCT Filed: Apr. 9, 2024
(86) PCT No.: PCT/EP2024/059559

§ 371 Date: Oct. 17, 2025

(30) Foreign Application Priority Data
Apr. 18, 2023 (DE) 10 2023 109 770.9

(51) Int. Cl. B67D 1/00; B67D 1/04; B67D 1/08; B67D 7/02

(52) U.S. Cl. CPC B67D 1/0078; B67D 1/0418; B67D 7/0294; B67D 2001/0812; B67D 2001/0822

(57) ABSTRACT

A container attachment with a container lid provided with a compressed gas line which extends through the container lid and which has a compressed gas inlet opening and a compressed gas outlet opening, a liquid line extends through the container lid and has a liquid outlet opening on and a liquid inlet opening, a shut-off valve connected in the liquid line, a shut-off valve actuation element mounted on the container lid and by which the shut-off valve can be actuated, and a flavour capsule which is detachably connectable or connected to the container lid and which has a capsule outlet opening, a capsule inlet opening and a capsule interior connecting these capsule openings to one another, the capsule inlet opening in a state of the flavour capsule connected to the container lid is connected to the liquid outlet opening.

### CROSS-REFERENCE TO RELATED APPLICATIONS

The present application is the U.S. National Phase entry of International Patent Application No. PCT/EP2024/059559 filed Apr. 9, 2024, which claims priority to German Patent Application No. 10 2023 109 770.9 filed Apr. 18, 2023, the contents of which are hereby incorporated by reference into this application.

### TECHNICAL FIELD

The present disclosure relates to a container attachment with a container lid provided with a lid upper side and with a lid bottom side, a compressed gas line extending through the container lid, which has a compressed gas inlet opening on the lid upper side and a compressed gas outlet opening on the lid bottom side, a liquid line extending through the container lid, having on the lid upper side a liquid outlet opening and on the lid bottom side a liquid inlet opening, a shut-off valve connected to the liquid line and a shut-off valve actuation element mounted on the container lid by which the shut-off valve can be actuated.

### BACKGROUND

Such a container attachment can be placed with its container lid on the opening of a liquid container filled with a liquid, such as a drinking bottle, and attached to it. If a gas capsule filled with a pressurised gas is then connected to the compressed gas inlet opening, gas flows into the interior of the liquid container, which can be used to push the liquid through the liquid line with the shut-off valve open, so that the liquid escapes from the liquid outlet opening. In this sense, the pressurised gas is used as a propellant for the liquid. The liquid escaping from the liquid outlet opening can then be introduced into a drinking vessel or directly into the mouth of a user, for example. If a taste-neutral liquid, such as water, is used, there is often a desire to flavour this liquid. However, a single flavour must be determined for the entire contents of the liquid container. Furthermore, the problem is that traces of the flavouring substance remain on the inner wall of the container after emptying and can thus pre-flavour subsequent liquid fillings, which is usually undesirable. There is also the problem that adding flavouring to the liquid container by a user can contaminate the liquid with germs, causing it to spoil prematurely.

Based on this, the present disclosure is based in particular on the problem of creating a flavouring option while avoiding at least one of the aforementioned disadvantages when a liquid is emptied from a liquid container.

### SUMMARY

According to the present disclosure, this problem is solved with a container attachment according to the present disclosure. Additional developments of the present disclosure are given in the following description.

A container attachment with a container lid provided with a lid upper side and with a lid bottom side, a compressed gas line which extends through the container lid and which has a compressed gas inlet opening on the lid upper side and a compressed gas outlet opening on the lid bottom side, a liquid line which extends through the container lid and which has a liquid outlet opening on the lid upper side and a liquid inlet opening on the lid bottom side, a shut-off valve connected in the liquid line and a shut-off valve actuation element which is mounted on the container lid and by which the shut-off valve can be actuated, is according to the present disclosure in particular further developed by a flavour capsule which is detachably connectable and/or connected to the container lid on the lid upper side and has a capsule outlet opening, a capsule inlet opening and a capsule interior connecting these capsule openings to one another, wherein the capsule inlet opening in the or a state of the flavour capsule connected to the container lid is connected to the

If a flavouring substance is introduced into the capsule interior, a liquid flowing from the capsule inlet opening through the capsule interior to the capsule outlet opening can be flavoured with the flavouring substance. If this liquid is emptied from a liquid container using the container attachment, the liquid is not flavoured inside the liquid container, but outside the liquid container by the flavour capsule. Since the flavour capsule is detachably connected to the container lid, it can be replaced with a different flavour capsule, in particular of the same construction, containing a different flavour substance or no flavour substance. This allows the flavour to be varied without having to replace the liquid in the liquid container. Furthermore, the flavour capsule is arranged in the direction of flow of the liquid behind the shut-off valve so that no liquid can flow from the flavour capsule back into the liquid container when the shut-off valve is closed. The introduction of germs into the liquid container by the flavour capsule can thus be avoided or at least significantly reduced.

In embodiments, the lid bottom side and the lid upper side are opposite each other in an axial direction. In embodiments, the container attachment and/or the container lid is assigned a longitudinal axis running in the or an axial direction, which runs in particular centrally through the container attachment and/or through the container lid. One or any direction transverse to the axial direction and/or transverse to the longitudinal axis is in particular referred to as the radial direction. In embodiments, a direction running around the longitudinal axis is referred to as a circumferential direction. In embodiments, the container attachment and/or the container lid have a cylindrical outer circumferential contour, which runs in particular in the circumferential direction.

The expression “on the lid upper side” refers to the or a side facing away from the lid bottom side and/or the or a side facing away from the or a liquid container. The expression “on the lid bottom side” refers to the or a side facing away from the lid bottom side and/or the or a side facing the liquid container. In particular, the expression “at least one” also has the meaning of “one” or “exactly one”.

In embodiments, the container attachment is made of plastic and/or metal. In particular, the container attachment forms a rigid body. In embodiments, the container lid is made of plastic and/or metal. In particular, the container lid forms a dimensionally stable body.

In embodiments, the container lid has a flavour capsule-receiving recess into which the flavour capsule can be inserted and/or introduced. In embodiments, the flavour capsule is introduced into the flavour capsule-receiving recess in or in a connected state to the container lid. In embodiments, the liquid outlet opening opens into the flavour capsule-receiving recess.

In embodiments, the flavour capsule is made of plastic and/or metal. In particular, the flavour capsule forms a dimensionally stable body. In embodiments, the flavour capsule forms a separate body. In embodiments, the capsule outlet opening is provided on a free end side of the flavour capsule, in particular arranged at an axial end of the flavour capsule. In embodiments, the capsule outlet opening is a clear opening. According to one possible embodiment, however, the capsule outlet opening is closed, in particular for the purpose of drip protection, with a closure with valve function and/or with a removable closure, such as with a cap or with a plug. A closure with valve function opens automatically, for example, when pressurised by the liquid and, in embodiments, is formed by a cut film, which is in particular made of plastic.

According to a first variant, the flavour capsule is provided, for example, with a spout forming the capsule outlet opening, which in particular forms an outlet. In embodiments, the capsule outlet opening is or forms a drinking opening. According to the first variant, the flavour capsule-receiving recess is designed as an end-face depression of the container lid provided in particular on the lid upper side.

According to a second alternative embodiment, the container lid comprises, for example, a termination line provided, in particular on the lid upper side, which has a termination line outlet opening and a termination line inlet opening, which in or in a connected state to the container lid of the flavour capsule, is connected to the capsule outlet opening. In embodiments, the termination line outlet opening is provided on a free end face of the container lid arranged in particular at an axial end of the container lid. According to the second variant, the flavour capsule-receiving recess is in particular designed in the form of a pocket. In embodiments, the termination line inlet opening opens into the flavour capsule-receiving recess. In embodiments, the termination line outlet opening is a clear opening. According to one possible embodiment, however, the termination line outlet opening is closed, in particular for the purpose of drip protection, with a closure with valve function and/or with a removable closure, such as with a cap or with a plug. A closure with valve function opens automatically, for example, when pressurised by the liquid and, in embodiments, is formed by a cut film, which is in particular made of plastic. In embodiments, the container lid is provided with a spout forming the termination line outlet opening, which in particular forms an outlet. In embodiments, the termination line outlet opening is or forms a drinking opening.

According to embodiments, a gas capsule is, in particular detachably, connectable and/or connected to the compressed gas inlet opening and, in embodiments, is filled with a pressurised gas Such gas capsules are available on the market for different purposes. Nevertheless, it should not be excluded that gas capsules manufactured specifically for the container attachment can be used, which are adapted to the container attachment, for example in terms of their connectability and/or their gas capsule closure and/or their shape and size and/or the type of gas and/or the pressure of the gas. The gas is carbon dioxide, for example. In embodiments, the pressure of the gas in the unused gas capsule is in particular greater than the atmospheric pressure at sea level. In embodiments, the pressure of the gas in the unused gas capsule is greater than 1 or 2 bar, for example.

According to embodiments, the compressed gas line has a gas capsule connection on the lid upper side. For example, the compressed gas line on the side of the lid upper side is provided with a, protruding and/or upright, hollow mandrel, which, in embodiments, has a tip with the compressed gas inlet opening at a free end. The mandrel forms, for example, the gas capsule connection or a gas capsule connection. In particular, conventional gas capsule closures, for example, can be easily pierced by the mandrel. In embodiments, the compressed gas line is made of plastic and/or metal. In embodiments, the compressed gas line forms a rigid body. In embodiments, the compressed gas line forms a separate body.

According to embodiments, a gas capsule chamber is provided on or in the container lid and/or on or in the container attachment, in which in particular the compressed gas inlet opening and/or the gas capsule connection and/or the mandrel is provided. In embodiments, the gas capsule chamber is closable and/or closed with a detachable gas capsule chamber cover. In embodiments, the gas capsule can be arranged and/or is arranged in the gas capsule chamber. By providing the gas capsule chamber and/or the gas capsule chamber cover, the gas capsule can be secured against accidental loosening or falling down, for example. In embodiments, the gas capsule chamber cover is made of plastic and/or metal.

According to embodiment, at least one reserve gas capsule chamber is provided on or in the container lid and/or on or in the container attachment, in which one or at least one reserve gas capsule can be arranged and/or is arranged. In embodiments, the reserve gas capsule is filled with a pressurised gas. In embodiments, the reserve gas capsule chamber can be and/or is closed with a removable reserve gas capsule chamber cover. By providing the reserve gas capsule chamber and/or the reserve gas capsule chamber cover, the reserve gas capsule or a reserve gas capsule can be carried easily. In embodiments, the reserve gas capsule chamber cover is made of plastic and/or metal.

According to embodiments, a valve is connected to the compressed gas line, which is in particular a check valve. In embodiments, the valve permits flow in the direction from the compressed gas inlet opening to the compressed gas outlet opening. In embodiments, the valve locks, in particular automatically, in the opposite direction, i.e. in the direction from the compressed gas outlet opening to the compressed gas inlet opening. Thus, a gas capsule connected to the compressed gas inlet opening can be removed from the compressed gas inlet opening again after gas is released into the liquid container without gas flowing out of the liquid container through the compressed gas line.

According to embodiments, the liquid line can be shut off and/or released by he shut-off valve. In embodiments, the shut-off valve, in particular by the shut-off valve actuation element, can be transferred to a state releasing the liquid line, in which the liquid line is released. In embodiments, the shut-off valve, in particular by the shut-off valve actuation element, can be transferred to a state that closes and/or shuts off the liquid line, in which the liquid line is closed and/or shut off. In embodiments, the shut-off valve is designed to be self-closing and/or self-blocking. In embodiments, the shut-off valve is provided on the lid upper side. In embodiments, the shut-off valve on the lid upper side is connected to the liquid line.

According to embodiments, the shut-off valve has a shut-off body which is movably, in particular slidably, mounted on the container lid, transverse to the axial direction and is coupled with the shut-off valve actuation element. In embodiments, the shut-off device can be moved, in particular by sliding, by the shut-off valve actuation element. The shut-off device is, for example, a slide valve. In embodiments, a through-hole, in particular axial, is provided in the shut-off device. In embodiments, the shut-off device can be positioned, in particular by the shut-off valve actuation element, in a position releasing the liquid line, in which the liquid line is released. In embodiments, the shut-off device can be positioned, in particular by the shut-off valve actuation element, in a position closing and/or shutting off the liquid line, in which the liquid line is closed and/or shut off. In the or a position of the shut-off device releasing the liquid line, the through-hole is connected in particular to the liquid line. In the or a position of the shut-off device closing the liquid line, the liquid line is in particular closed and/or shut off by the shut-off device. In embodiments, the shut-off valve has a return spring which pushes the shut-off body into the or a position closing and/or shutting off the liquid line and against the spring force of which the shut-off body, in particular by the shut-off valve actuation element, is movable, in particular slidable, into the or a position releasing the liquid line. In embodiments, the shut-off device can be positioned and/or reset, in particular by the return spring, in the or a position closing and/or shutting off the liquid line, in which the liquid line is closed and/or shut off. In embodiments, the return spring, in particular with a spring end, is supported on the container lid. In embodiments, the return spring, in particular with another spring end, is supported on the shut-off device.

In embodiments, the shut-off valve actuation element is provided on the lid upper side. In embodiments, the shut-off valve actuation element is mounted on the lid upper side on the container lid, in particular movably, movably transverse to the axial direction. For example, the shut-off valve actuation element is pivotably or slidably mounted on the lid upper side on the container lid. In particular, the shut-off valve can be transferred by the shut-off valve actuation element from the or a state closing and/or shutting off the liquid line to the or a state releasing the liquid line. In addition, the shut-off valve can be transferred, for example by the shut-off valve actuation element, from the or a state releasing the liquid line to the or a state closing and/or shutting off the liquid line. For example, the shut-off valve actuation element is a lever or pushbutton mounted movably on the container lid. In embodiments, the shut-off valve actuation element is made of plastic and/or metal. In particular, the shut-off valve actuation element forms a dimensionally stable body.

In embodiments, a flavouring substance can be introduced and/or is introduced into the capsule interior of the flavour capsule. In embodiments, the flavouring substance or at least a part of the flavouring substance can be released to the liquid or a liquid flowing through the capsule interior. The or a release of the flavouring substance or at least a part of the flavouring substance to the liquid or a liquid flowing through the capsule interior can take place, for example, directly or indirectly. For example, the or a release of the flavouring substance or at least a part of the flavouring substance to the liquid or a liquid flowing through the capsule interior takes place by diffusion. In embodiments, the flavouring substance is a food-grade and/or non-toxic flavouring substance.

In embodiments, the flavour capsule is designed such that the flavouring substance is replaceable and/or refillable. This means that the flavour capsule can be used multiple times, for example. For example, for this purpose, the flavour capsule is provided with a filling opening, which can be closed and/or is closed, for example with in particular a removable, closure or lid, by which the filling opening is in particular released. Alternatively, the flavour capsule is for example designed in such a way that it cannot be opened without destruction. This may be useful for hygienic reasons, for example.

In embodiments, the flavour capsule, in particular by a linear guide, in embodiments, in a radial direction and/or transverse to the axial direction, is mounted and/or guided slidably on the container lid. For example, the flavour capsule can be secured and/or is secured with a form-fit to the container lid by at least one detachable latching or snap connection. In addition or alternatively, the flavour capsule can be secured and/or is secured to the container lid, for example, by at least one detachable force-fit connection. In embodiments, the flavour capsule has at least one, in embodiments, linear, engagement element, which is provided on the container lid with at least one, in embodiments, linear, counter-engaging element, which is in particular sliding, and acts together and/or meshes with one another. For example, the flavour capsule each has at least one, in embodiments, linear, engagement element on two opposite sides, wherein the engagement elements have on the container lid at least two, in embodiments, opposite, in embodiments, linear, counter-engaging elements, which are in particular sliding, and act together and/or mesh with one another. The engagement and counter-engagement elements are, for example, rails and/or sliding guides. In embodiments, each engagement element and/or each counter-engagement element runs transverse to the axial direction and/or in a direction running transverse to the axial direction.

In embodiments, at least one sealing element, such as a sealing ring, is provided and/or provided between the flavour capsule and the upper side of the container. By the at least one sealing element, for example, the interface between the capsule inlet opening and the liquid outlet opening, in particular to the outside, can be sealed and/or is sealed. In embodiments, the at least one sealing element surrounds the capsule inlet opening and/or the liquid outlet opening. The at least one sealing element consists in particular of an elastic material. For example, the at least one sealing element, in particular in the axial direction, is clampable and/or is clamped. Thus, the aforementioned frictional connection can be realised, for example, by the at least one sealing element pressing the flavour capsule and/or its engagement element(s), in particular in an axial direction, against a part of the container lid and/or against its counter-engagement element(s).

In embodiments, a projection surrounding the capsule inlet opening, in particular axial, is provided on the flavour capsule, which can for example, in particular axially, be pushed in and/or is pushed into the liquid outlet opening or into a recess surrounding this. Alternatively, a protrusion surrounding the liquid outlet opening, in particular axial, is provided for example on the container lid, which can for example, in particular axially, be pushed in and/or is pushed into the capsule inlet opening or into a recess surrounding this. This enables, for example, the aforementioned latching or snap connection to be realised.

In embodiments, the liquid line protrudes on the lid bottom side, in particular in the axial direction, from the container lid. Thus, the liquid line can, for example, engage in the or a liquid container and/or immerse in the or a liquid, in particular introduced into the liquid container. The liquid line is, for example, shaped as one piece or in several parts.

In embodiments, the liquid line has a first part provided in or on the container lid and a second part connected thereto, which protrudes from the container lid in particular on the lid bottom side, in embodiments, in an axial direction. In embodiments, the liquid line or the first part of the liquid line or at least the first part of the liquid line is integrated in the container lid. In embodiments, the or a part of the liquid line protruding from the container lid on the lid bottom side, in embodiments, in an axial direction, and/or the second part of the liquid line, in particular at least partially, is flexible or rigid. For example, the or a part of the liquid line protruding from the container lid on the lid bottom side, in embodiments, in an axial direction, and/or the second portion of the liquid line, in particular at least partially, is formed as a hose or pipe.

The second part of the liquid line may be integrated in and/or be formed as one piece with the first part of the liquid line. Alternatively, the second part of the liquid line forms a separate body, for example. In embodiments, the first part of the liquid line and the second part of the liquid line are rigid, connectable and/or connected to each other. For example, the first part of the liquid line and the second part of the liquid line are interconnectable and/or are interconnected and/or are screwable and/or are screwed together. In embodiments, the second part of the liquid line can be connected and/or is connected to the first part of the liquid line. For example, the first part of the liquid line has a connection opening or spout provided on the lid bottom side, on or onto or into which, for example, the second part of the liquid line can be connected and/or is connected and/or can be attached or plugged in and/or is attached or plugged in or can be screwed on or in and/or is screwed on or in.

The or a part of the liquid line provided in or on the container lid and/or the first part of the liquid line is also referred to as a lid section of the liquid line, for example. The or a part of the liquid line and/or the second portion of the liquid line protruding from the container lid on the lid bottom side, in embodiments, in an axial direction, is for example also referred to as an immersion section of the liquid line. With the immersion section, the liquid line can interfere in particular with the or a liquid container and/or immerse in the or a liquid, in particular introduced into the or a liquid container. In embodiments, the lid section runs, in particular at least partially, in an axial direction. In embodiments, the immersion section runs, in particular at least partially, in the axial direction or obliquely to the axial direction.

According to embodiments, the container attachment has a container fastening area, which is provided in particular on the container lid and/or on a container fastening means connected to the container lid. In embodiments, the container fastening area and/or the container fastening means are provided on the lid bottom side. In embodiments, the container fastening means is firmly and/or rigidly connected to the container lid. In particular, the container fastening means is integrated in the container lid. In embodiments, the container lid can be fastened and/or is fastened, in particular detachably, to the or a liquid container by the container fastening region. In particular, the container fastening area is cylindrical or hollow cylindrical. For example, the container fastening area is designed in the shape of a tube. In embodiments, the container fastening area and/or the container fastening means is formed by a rod piece or pipe piece protruding in particular from the container lid. For example, the rod piece or the pipe piece is integrated in the container lid. In embodiments, the container fastening area and/or the rod piece or the pipe piece, in particular at least in its end area facing away from the container lid, is provided with a thread which is, for example, an internal thread or an external thread. In embodiments, the container attachment can be screwed and/or is screwed to the liquid container, in particular by the container fastening area. Alternatively, the container fastening area has, for example, a, in particular first, part of a plug-in closure. For example, the container attachment can be fastened and/or is fastened, in particular in a force-fit and/or form-fit manner, to the liquid container by the or a plug-in closure.

The present disclosure further relates in particular to a liquid container with a container interior, a container opening and a container attachment according to the present disclosure, which, in embodiments, can be fastened and/or is fastened to the liquid container. In embodiments, the container opening can be closed and/or is closed by the container lid. In embodiments, the container lid closes the container opening. In embodiments, the container interior is accessible through the container opening.

The liquid container according to the present disclosure can be further developed in accordance with all embodiments explained in connection with the container attachment according to the present disclosure. Furthermore, the container attachment according to the present disclosure can be further developed according to all embodiments explained in connection with the liquid container according to the present disclosure.

In embodiments, the liquid line extends, in particular on the lid bottom side, in embodiments, in the axial direction, into the container interior. In embodiments, the second part of the liquid line and/or the immersion section of the liquid line extends, in embodiments, in the axial direction or obliquely to the axial direction, into the container interior. In embodiments, a liquid is introduced into the container interior. The liquid is in particular a taste-neutral liquid. For example, the liquid is water or aqueous. Alternatively, the liquid can also be flavoured. In embodiments, the liquid line extends, in particular on the lid bottom side, in embodiments, in the axial direction or obliquely to the axial direction, into the liquid. In embodiments, the second part of the liquid line and/or the immersion section of the liquid line extends, in embodiments, in the axial direction or obliquely to the axial direction, into the liquid.

According to embodiments, the fluid container has an attachment fastening area. In embodiments, the container attachment and/or the container lid can be connected and/or is connected to the liquid container and/or can be fastened and/or is fastened to the liquid container by the container fastening area, in particular in the attachment fastening area. In embodiments, the attachment fastening area is provided in the area of the container opening. For example, the attachment fastening area surrounds and/or encircles the container opening. The attachment fastening area is in particular cylindrical or hollow cylindrical. For example, the attachment fastening area is designed in the shape of a tube. In embodiments, the liquid container is provided with an external thread or with an internal thread in the attachment fastening region. In embodiments, the container attachment, in particular by the container fastening area, in embodiments, in the attachment fastening region, can be screwed and/or is screwed to the liquid container. Alternatively, the attachment fastening region has, for example, a, in particular second or other, part of the or a plug-in closure. For example, the container attachment can be fastened and/or is fastened, in particular in a force-fit and/or form-fit manner, to the liquid container by the or a plug-in closure.

According to embodiments, an aeration valve is provided on the liquid container and/or on the container attachment, for example respectively. In embodiments, the container interior is connectable and/or connected to the surrounding environment, in embodiments, to the air of the surrounding environment, by the aeration valve. In embodiments, the aeration valve is designed to be self-closing and/or self-locking. The aeration valve makes it possible in particular to avoid or compensate for a negative pressure in the container interior during liquid emptying, e.g. if the gas supply of the gas capsule is exhausted and, for example, no reserve gas capsule is available. In embodiments, an aeration valve actuation element mounted on the liquid container or on the container lid is provided, by which the aeration valve can be actuated.

If the or an aeration valve is provided on the container attachment, this comprises an aeration line extending through the container lid, which has an aeration inlet opening on the lid upper side and an aeration outlet opening on the lid bottom side. In particular, the aeration valve is connected to the aeration line.

If the or an aeration valve is provided on the liquid container, this comprises an aeration line which extends through a container wall delimiting the container interior and which has an aeration inlet opening to the outside, i.e. in particular to the surrounding environment, and an aeration outlet opening to the container interior. In particular, the aeration valve is connected to the aeration line.

### BRIEF DESCRIPTION OF THE DRAWINGS

The present disclosure will be described below on the basis of embodiments with reference to the drawing. In the drawings:

FIG. 1 side view of a liquid container with a container attachment according to one embodiment,

FIG. 2 side view of the container attachment,

FIG. 3 side view of the container,

FIG. 4 perspective view of the container attachment from below at an angle,

FIG. 5 perspective view of the container attachment from above at an angle,

FIG. 6 view according to FIG. 5 with flavour capsule and covers removed,

FIG. 7 perspective view of a container lid of the container attachment from above at an angle,

FIG. 8 perspective view of the container lid from from below at an angle,

FIG. 9 partially transparent side view of the container lid,

FIG. 10 side view of a shut-off valve and a compressed gas line,

FIG. 11 perspective view of the shut-off valve and the compressed gas line,

FIG. 12 partially transparent side view of the container lid without shut-off valve and compressed gas line,

FIG. 13 perspective view of the flavour capsule from above at an angle, and

FIG. 14 perspective view of the flavour capsule from below at an angle.

### DETAILED DESCRIPTION

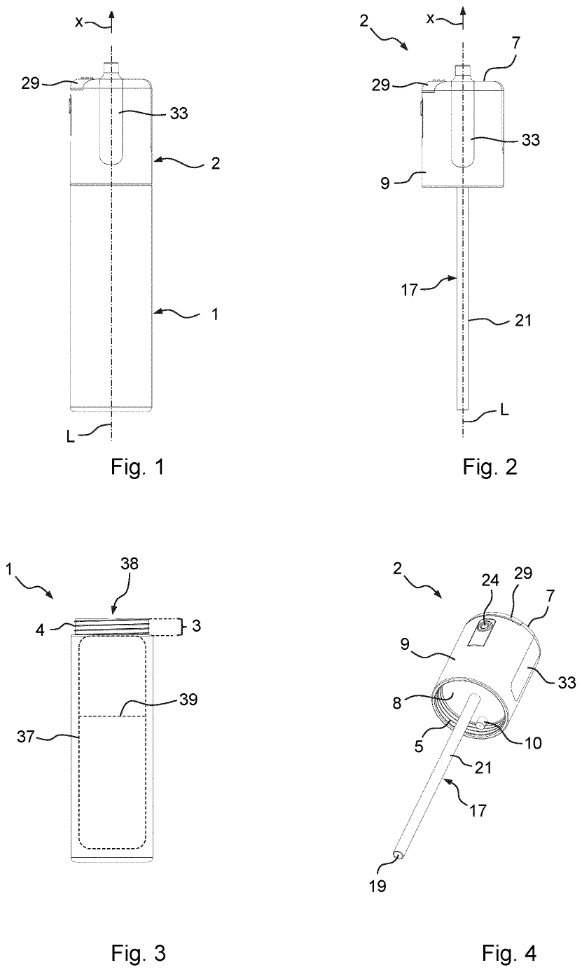

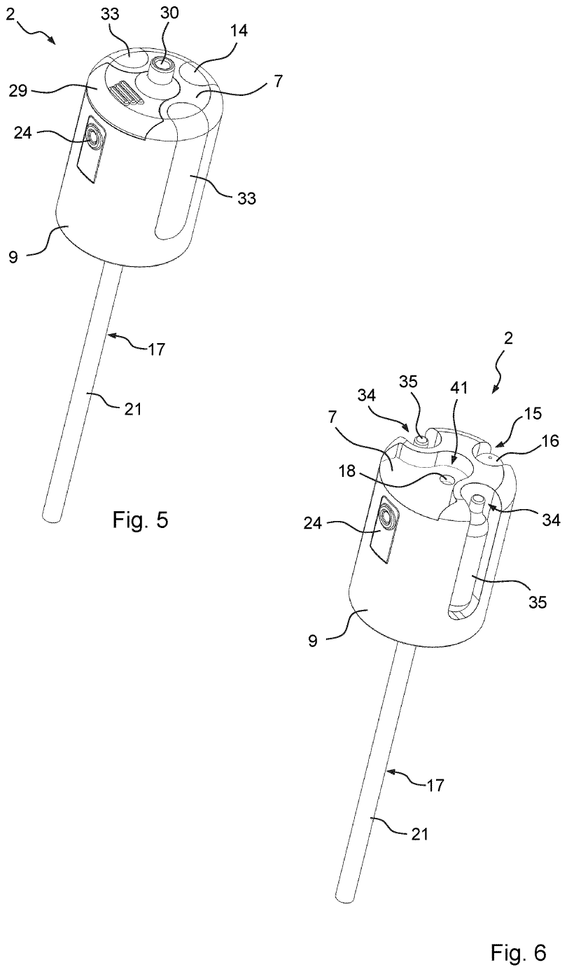

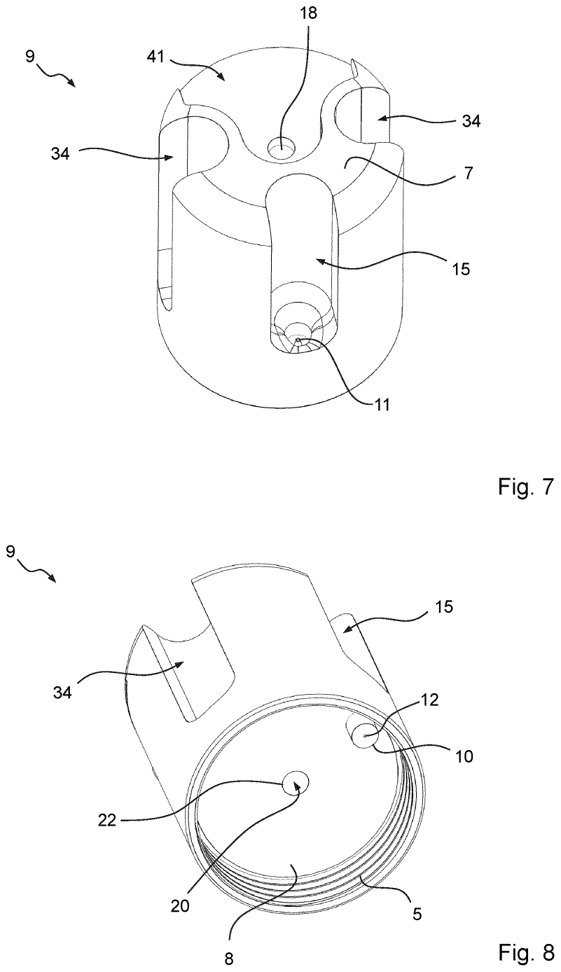

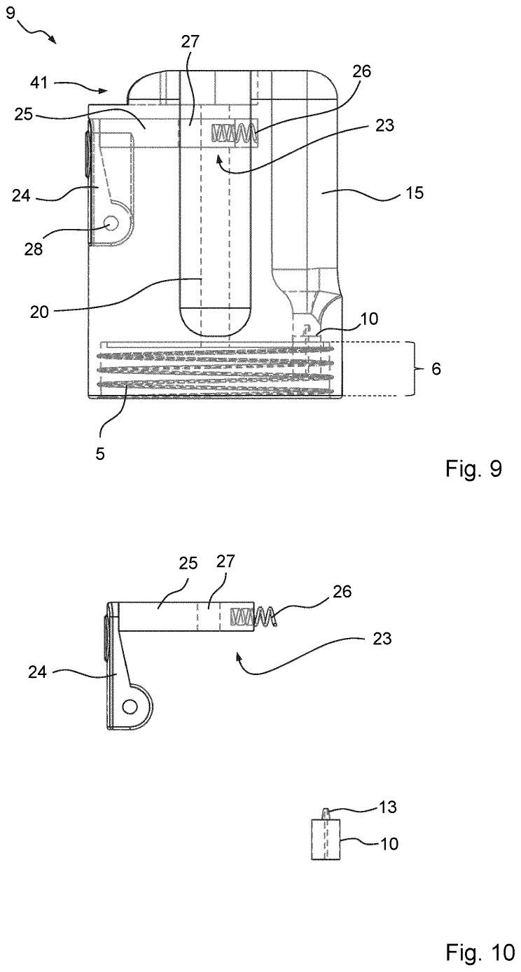

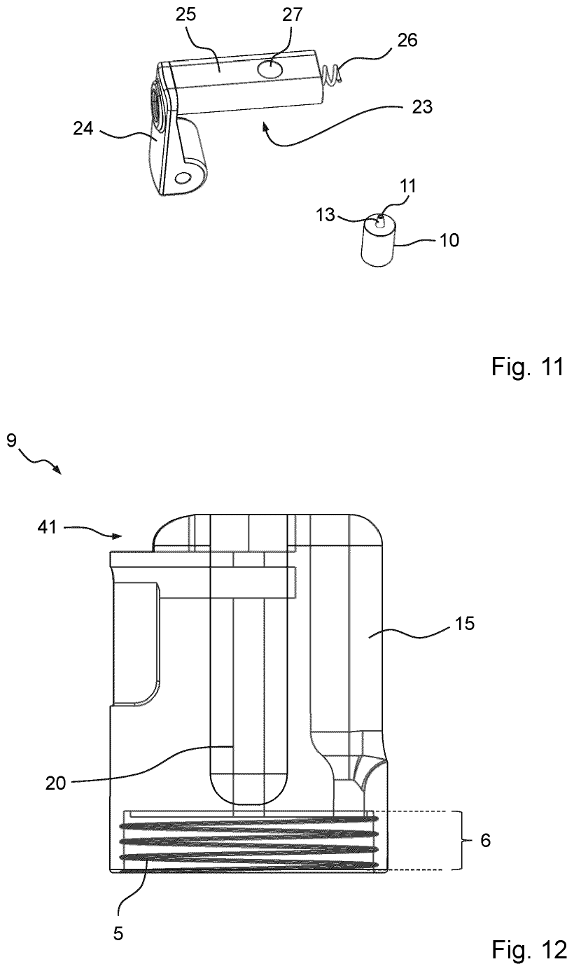

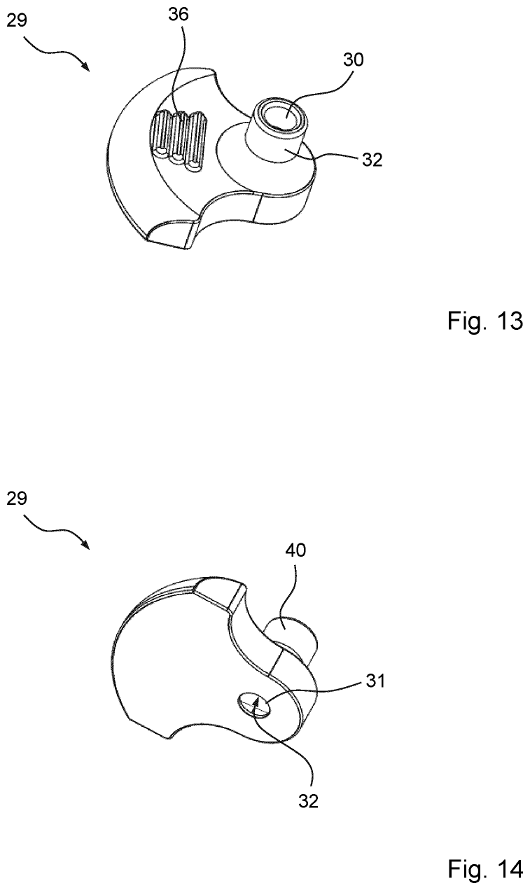

From FIG. 1, a side view of a liquid container 1 with a container attachment 2 attached thereto in accordance with an embodiment can be seen, which is shown in detail in FIG. 2. Furthermore, the liquid container 1 is shown individually in FIG. 3. In addition, FIGS. 4 to 14 show different views and partial views of the container attachment 2 or parts of the container attachment 2.

The container attachment 2 can be screwed onto the fluid container 1, which is provided for this purpose in an attachment fastening area 3 with an external thread 4 on which the container attachment 2 can be screwed on with an internal thread 5, which is provided on a hollow cylindrical container fastening area 6 of the container attachment 2. The bolted state of the container attachment 2 and the liquid container 1 is shown in FIG. 1.

The liquid container 1 comprises a container interior 37 indicated only schematically and a container opening 38 through which the container interior 37 is accessible, through which in particular a liquid 39 is introduced.

The container attachment 2 has a container lid 9 provided with a lid upper side 7 and a lid bottom side 8, wherein the lid upper side 7 and the lid bottom side 8 are opposite to each other in an axial direction x. Furthermore, a longitudinal axis L is assigned to the container lid 9, which runs in the axial direction x centrally through the container lid 9.

The container attachment 2 additionally comprises a compressed gas line 10 extending through the container lid 9, which has a compressed gas inlet opening 11 on the lid upper side 7 and a compressed gas outlet opening 12 on the lid bottom side 8. In this case, the compressed gas line 10 is provided on the lid upper side 7 with a hollow mandrel 13, which has a tip with the compressed gas inlet opening 11 at a free end. A gas capsule chamber 15, which can be closed with a removable gas capsule chamber cover 14, is provided in the container lid 9, in which the mandrel 13 is arranged with the compressed gas inlet opening 11. Thus, a gas capsule 16 can be inserted into the gas capsule chamber 15 and connected to the compressed gas inlet opening 11. In embodiments, a check valve is connected to the compressed gas line which permits flow in the direction from the compressed gas inlet opening 11 to the compressed gas outlet opening 12 and blocks in the opposite direction.

The container attachment 2 further has a liquid line 17 extending through the container lid 9, which has a liquid outlet opening 18 on the lid upper side 7 and a liquid inlet opening 19 on the lid bottom side 8.

The liquid line 17 is provided with a first part 20 provided in the container lid 9 and a second part 21 connected thereto, which protrudes from the container lid 9 on the lid bottom side 8, in particular axially. In this case, the first part 20 can also be designated as a lid section of the liquid line 17 and the second part 21 can also be designated as an immersion section of the liquid line 17. The first part 20 of the liquid line 17 has a connection opening 22 which is provided on the lid bottom side 8 and to which in particular the second part 21 of the liquid line 17 is connectable and/or is connected. In embodiments, the second part 21 of the liquid line 17 can be inserted and/or is inserted into the connection opening 22. Alternatively, the first of the part 20 of the liquid line 17 and the second of the part 20 of the liquid line 17 may also be formed as one piece and/or integrally with one another.

The container attachment 2 further has a shut-off valve 23 connected to the liquid line 17 and a shut-off valve actuation element 24 mounted on the container lid 9, by which the shut-off valve 23 can be actuated.

The shut-off valve 23 is provided with a shut-off body 25 coupled with the shut-off valve actuation element 24 and guided slidably in the container lid 9 as well as with a return spring 26 which is supported on the container lid 9, pushes the shut-off body 25 into a position closing the liquid line 17 and against whose spring force the shut-off body 25 can be moved by the shut-off valve actuation element 24 into a position releasing the liquid line 17, wherein a through-hole 27 provided in the shut-off body 25 releases the liquid line 17. The shut-off valve actuation element 24 is pivotably mounted on the container lid 9 by a bearing element 28.

The container attachment 2 additionally has a flavour capsule 29 which is detachably connectable and/or is connected to the container lid 9 on the lid upper side 7 and which comprises a capsule outlet opening 30, a capsule inlet opening 31 and a capsule interior 32 connecting these capsule openings 30 and 31 to one another, wherein the capsule inlet opening 31 in a state of the flavour capsule 29 connected to the container lid 9 is connected to the liquid outlet opening 18. For this purpose, the container lid 9 has a flavour capsule-receiving recess 41 into which the flavour capsule 29 can be inserted and/or is inserted, wherein the liquid outlet opening 18 leads into the flavour capsule-receiving recess 41. Here, the flavour capsule-receiving recess 41 is designed in the form of an end-face depression of the container lid 9, for example. In particular, the flavour capsule 29 is provided with a spout 40 forming the capsule outlet opening 18. To facilitate the detachment of the flavour capsule 29 from the container lid 9, the flavour capsule 29 has surface profiling 36 on its outer surface.

The container attachment 2 additionally comprises two closable reserve gas capsule chambers 34 provided in the container lid 9 each with a removable reserve gas capsule chamber cover 33 in which a reserve gas capsule 35 can be arranged and/or is arranged respectively. The reserve gas capsules 35 are each filled with a pressurised gas.

### List of Reference Numerals

1 Liquid container
2 Container attachment
3 Attachment fastening area
4 External thread
5 Internal thread
6 Container fastening area
7 Lid upper side
8 Lid bottom side
9 Container lid
10 Compressed gas line
11 Compressed gas inlet opening
12 Compressed gas outlet opening
13 Mandrel
14 Gas capsule chamber cover
15 Gas capsule chamber
16 Gas capsule
17 Liquid line
18 Liquid outlet opening
19 Liquid inlet opening
20 First part of the liquid line
21 Second part of the liquid line
22 Connection opening
23 Shut-off valve
24 Shut-off valve actuation element
25 Shut-off device
26 Return spring
27 Through-hole
28 Bearing element
29 Flavour capsule
30 Capsule outlet opening
31 Capsule inlet opening
32 Capsule interior
33 Reserve gas capsule chamber cover
34 Reserve gas capsule chamber
35 Reserve gas capsule
36 Surface profiling
37 Container interior
38 Container opening
39 Liquid
40 Spout
41 Flavour capsule-receiving recess
L Longitudinal axis
x Axial direction

1. A container attachment with a container lid provided with a lid upper side and with a lid bottom side, a compressed gas line which extends through the container lid and which has a compressed gas inlet opening on the lid upper side and a compressed gas outlet opening on the lid bottom side, a liquid line which extends through the container lid and which has a liquid outlet opening on the lid upper side and a liquid inlet opening on the lid bottom side, a shut-off valve connected in the liquid line and a shut-off valve actuation element mounted on the container lid and by which the shut-off valve may be actuated,
wherein a flavour capsule which is detachably connectable and/or connected to the container lid on the lid upper side and which has a capsule outlet opening, a capsule inlet opening and a capsule interior connecting the capsule outlet and the capsule inlet,
wherein the capsule inlet opening in a state of the flavour capsule connected to the container lid is connected to the liquid outlet opening.

2. The container attachment according to claim 1, wherein the compressed gas line is provided on the lid upper side with a hollow mandrel, which has a tip with the compressed gas inlet opening at a free end.

3. The container attachment according to claim 1, wherein a gas capsule, which is filled with a gas under pressure, is detachably connected or connectable to the compressed gas inlet opening.

4. The container attachment according to claim 3, wherein gas capsule chamber is provided on or in the container lid, in which the compressed gas inlet opening is provided and the gas capsule may be arranged or is arranged.

5. The container attachment according to claim 4, wherein at least one reserve gas capsule chamber is provided on the container lid, in which a reserve gas capsule may be arranged or is arranged, which is filled with a gas under pressure.

6. The container attachment according to claim 1, wherein a check valve is connected to the compressed gas line which permits flow in a direction from the compressed gas inlet opening to the compressed gas outlet opening and blocks in an opposite direction.

7. The container attachment according to claim 1, wherein the shut-off valve is self-closing.

8. The container attachment according to claim 1, wherein the shut-off valve has a shut-off body slidably mounted on the container lid and a return spring which pushes the shut-off body into a position closing the liquid line and against whose spring force the shut-off body may be moved by the shut-off valve actuation element into a position releasing the liquid line.

9. The container attachment according to claim 1, wherein a flavouring substance may be introduced into the capsule interior of the flavour capsule.

10. The container attachment according to claim 1, wherein the liquid line protrudes from the container lid on the lid bottom side.

11. A liquid container with a container interior, a container opening and a container attachment according to claim 1, which is attached to the liquid container and closes the container opening.

12. The liquid container according to claim 11, wherein a liquid is introduced into the container interior.

13. The container attachment according to claim 2, wherein a gas capsule, which is filled with a gas under pressure, is detachably connected or connectable to the compressed gas inlet opening.

14. The container attachment according to claim 13, wherein a gas capsule chamber is provided on or in the container lid, in which the compressed gas inlet opening is provided and the gas capsule may be arranged or is arranged.

15. The container attachment according to claim 14, wherein at least one reserve gas capsule chamber is provided on the container lid, in which a reserve gas capsule may be arranged or is arranged, which is filled with a gas under pressure.

16. The container attachment according to claim 2, wherein a check valve is connected to the compressed gas line which permits flow in a direction from the compressed gas inlet opening to the compressed gas outlet opening and blocks in an opposite direction.

17. The container attachment according to claim 3, wherein a check valve is connected to the compressed gas line which permits flow in a direction from the compressed gas inlet opening to the compressed gas outlet opening and blocks in an opposite direction.

18. The container attachment according to claim 4, wherein a check valve is connected to the compressed gas line which permits flow in a direction from the compressed gas inlet opening to the compressed gas outlet opening and blocks in an opposite direction.

19. The container attachment according to claim 5, wherein a check valve is connected to the compressed gas line which permits flow in a direction from the compressed gas inlet opening to the compressed gas outlet opening and blocks in an opposite direction.

20. The container attachment according to claim 1, wherein the shut-off valve is self-closing.
